(19) United States
(12) Patent Application Publication
(10) Pub. No.: US 2009/0007884 A1
(43) Pub. Date: Jan. 8, 2009

(54) DUAL THROTTLE ASSEMBLY WITH ELECTRONIC OVERRIDE

(76) Inventors: Jonathan M. Bunne, Elkhorn, WI (US); Daniel D. Hurda, Mequon, WI (US); Anthony D. Stefanelli, Elkhorn, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/772,527

(22) Filed: Jul. 2, 2007

(51) Int. Cl. F02D 11/10; B62K 11/00

(52) U.S. Cl. 123/399; 180/219

(57) ABSTRACT

An intake power control for an engine includes an electrically operable actuator coupled to a first throttle plate. Movement of the electrically operable actuator directly causes movement of the first throttle plate. A manually operable actuator is coupled to the electrically operable actuator, and movement of the manually operable actuator selectively causes movement of the first throttle plate. A linkage couples the first throttle plate to a second throttle plate of a second throttle body. The linkage is movable in response to movement of the first throttle plate to synchronize the movement of the second throttle plate with the movement of the first throttle plate.

### BACKGROUND

The present invention relates to a power control device and throttle assembly for a motorcycle engine.

The power of a motorcycle engine is controlled in some situations by an engine control module that senses a variety of operating parameters and selectively controls the power of the motorcycle when several parameters fall within a predetermined range. Conventionally, the power is reduced by shutting off fuel to the engine or cutting out the spark. Although these techniques control the power, they also tend to induce non-optimal running conditions, which ultimately cause increased noise emissions from the engine due to backfires and misfires.

### SUMMARY

In one embodiment, the invention provides an intake power control for an engine including a first throttle body defining a first air intake passage of the engine, a first throttle plate positioned within the first throttle body and movable between an idle position allowing a first amount of air to flow through the first air intake passage and a second position allowing more than the first amount of air to flow through the first air intake passage, an electrically operable actuator coupled to the first throttle plate, movement of the electrically operable actuator directly causing movement of the first throttle plate, and a manually operable actuator coupled to the electrically operable actuator, movement of the manually operable actuator selectively causing movement of the first throttle plate. The intake power control further includes a second throttle body defining a second air intake passage of the engine, a second throttle plate positioned within the second throttle body and movable between an idle position allowing a first amount of air to flow through the second air intake passage and a second position allowing more than the first amount of air to flow through the second air intake passage, and a linkage coupling the first throttle plate and the second throttle plate, the linkage movable in response to movement of the first throttle plate to synchronize the movement of the second throttle plate with the movement of the first throttle plate.

In another embodiment, the invention provides a method of controlling a motorcycle engine having two throttle bodies defining first and second air intake passages, first and second throttle plates being positioned within the first and second air intake passages, respectively. The method includes operating the engine, manually actuating the first throttle plate with a throttle control to increase the amount of air entering the engine through the first air intake passage, and automatically actuating the second throttle plate in association with the first throttle plate to increase the amount of air entering the engine through the second air intake passage. A triggering condition is sensed, and the first throttle plate is electrically actuated to decrease the amount of air entering the engine through the first air intake passage without moving the throttle control. The second throttle plate is automatically actuated in association with the first throttle plate to decrease the amount of air entering the engine through the second air intake passage.

Other aspects of the invention will become apparent by consideration of the detailed description and accompanying drawings.

### BRIEF DESCRIPTION OF THE DRAWINGS

FIG. 1 is a side view of a motorcycle having an intake power control embodying the present invention.

FIG. 2 is a perspective view of the intake power control in the motorcycle of FIG. 1. The intake power control is in an idle, at-rest position.

FIG. 3 is a front view of a portion of the intake power control illustrated in FIG. 2. The intake power control is in the idle, at-rest position.

FIG. 4 is a rear perspective view of the portion of the intake power control illustrated in FIG. 3. The intake power control is in the idle, at-rest position.

FIG. 5 is a top view of the portion of the intake power control illustrated in FIG. 3. The intake power control is in the idle, at-rest position. First and second throttle plates are in closed positions.

FIG. 6 is a front view of the portion of the intake power control illustrated in FIG. 3. First and second cable wheels are rotated from the positions of FIGS. 2-5 to open-throttle positions. The first and second throttle plates are rotated from the closed positions of FIG. 5 to open positions.

FIG. 7 is a rear view of the portion of the intake power control illustrated in FIG. 3. The first and second cable wheels are in the open-throttle positions. The first and second throttle plates are in the open positions.

FIG. 8 is a front view of the portion of the intake power control illustrated in FIG. 3. The second cable wheel is in the open-throttle position, and the first cable wheel is in the override position.

FIG. 9 is a partial cross-sectional view of the portion of the intake power control taken along line 9-9 of FIG. 2.

FIG. 10 is a partial cross-sectional view of the portion of the intake power control taken along line 10-10 of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

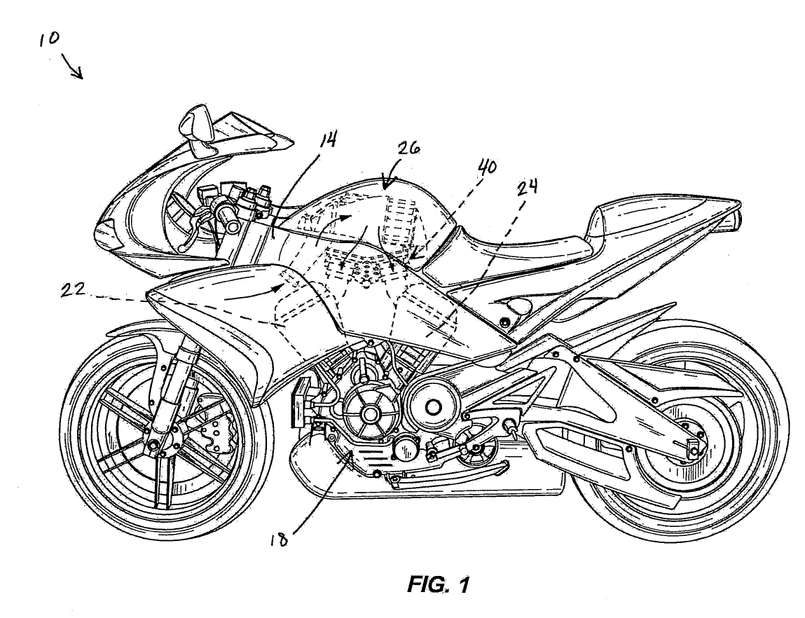

FIG. 1 illustrates a motorcycle 10 that includes a frame 14 and an engine 18 connected to the frame 14. The engine 18 is a V-twin style engine having a front cylinder 22 and a rear cylinder 24. Air for combustion in the engine 18 is passed through an airbox 26 where it is filtered before entering the engine 18. The amount of air delivered to the cylinders 22, 24 is controlled by a throttle assembly 40.

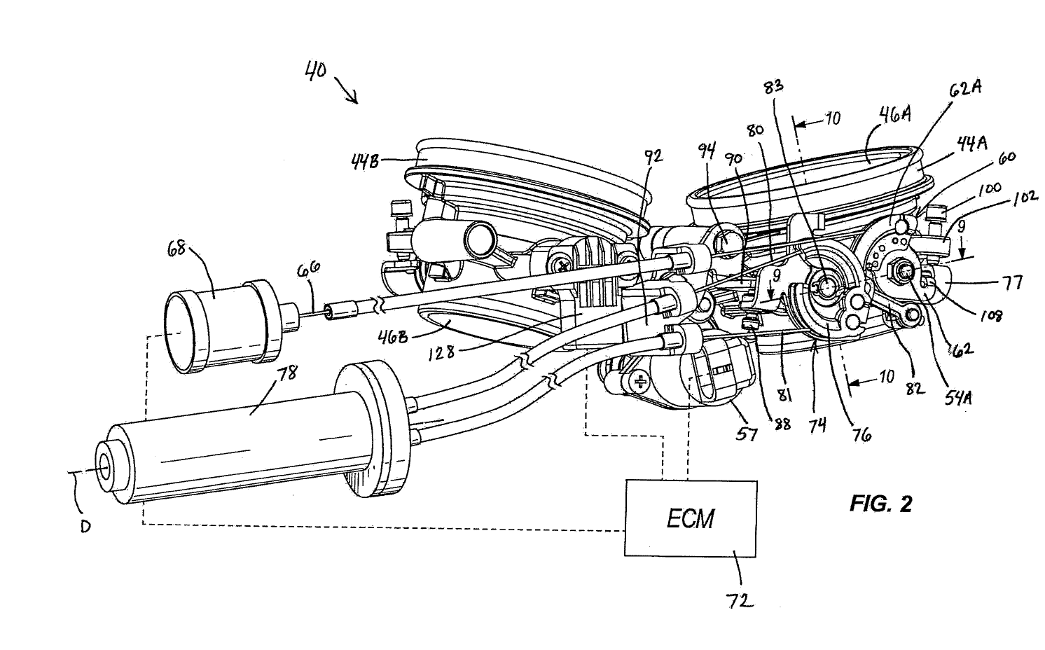

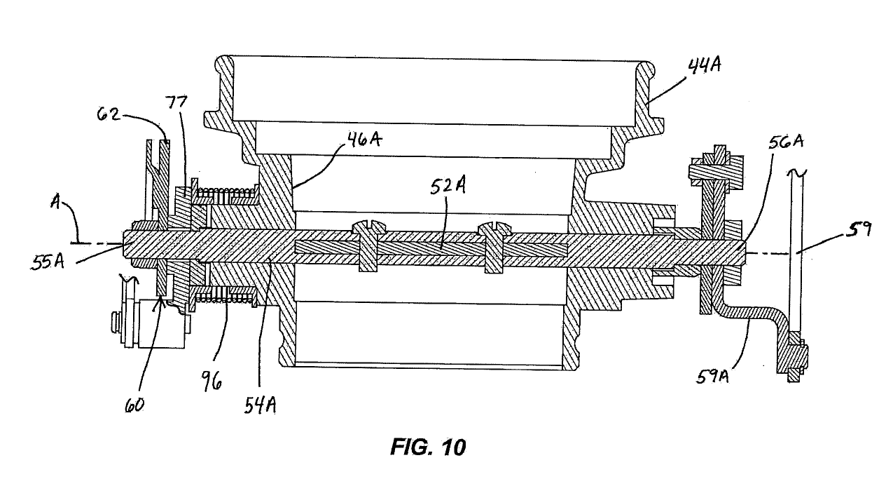

As shown in FIGS. 2-10, the throttle assembly 40 includes dual throttle bodies 44A, 44B defining air passages 46A, 46B, valves 48A, 48B positioned within the dual throttle bodies 44A, 44B, and a control system coupled to the valves 48A, 48B to control the position of the valves 48A, 48B within the throttle bodies 44A, 44B. The throttle bodies 44A, 44B are coupled to the engine 18 so that the valves 48A, 48B control the amount of airflow to the engine 18.

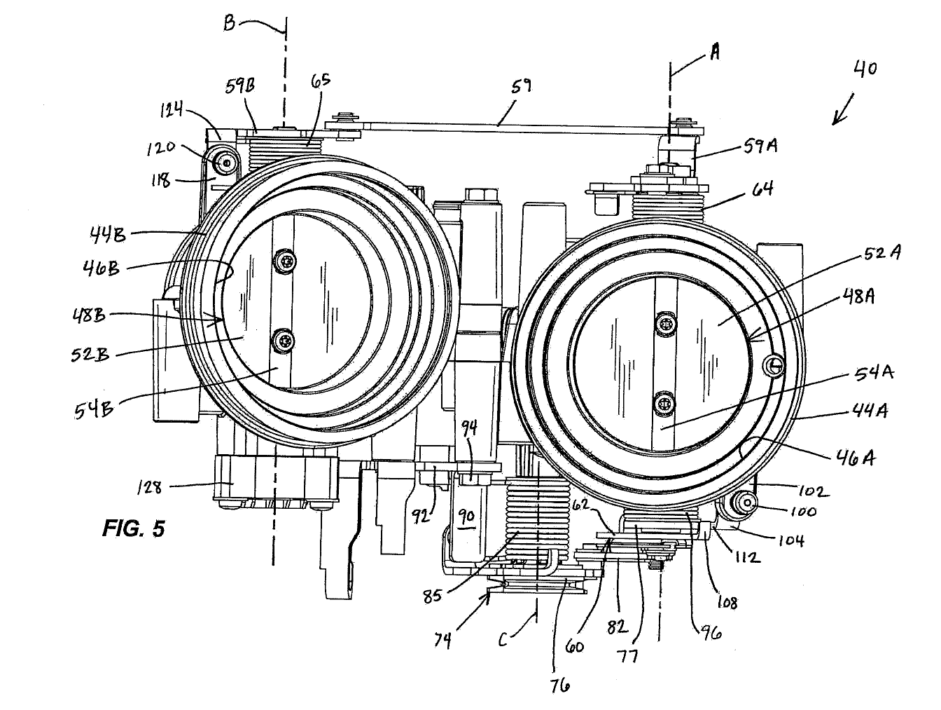

The valves 48A, 48B include respective first and second throttle plates 52A, 52B (FIGS. 5-7) and first and second shafts 54A, 54B coupled to the respective throttle plates 52A, 52B. The shafts 54A, 54B are rotatable with respect to the throttle bodies 44A, 44B to change the orientation of the throttle plates 52A, 52B relative to the air passages 46A, 46B. Respective ends 55A, 56A of the first shaft 54A extend through the first throttle body 44A. The first shaft 54A is biased to orient the throttle plate 52A in the closed position shown in FIG. 5. In this position, little or no air is allowed to pass through the air passage 46A. An idle air control 57 is electrically controlled to allow enough air to pass through a secondary air passage to allow the engine 18 to idle when the throttle plates 52A, 52B are positioned to close the air passages 46A, 46B. The second end 56A of the first shaft 54A is coupled to a linkage 59 that is further coupled to the second shaft 54B such that the first and second throttle plates 52A and 52B rotate simultaneously for synchronous opening/closing as further described below.

The second shaft 54B includes a first end 55B and a second end 56B. The respective second ends 56A, 56B of the first and second shafts 54A, 54B are both coupled to the linkage 59. The first shaft 54A is connected to the linkage 59 through a first transfer linkage 59A. The second end 56B of the second shaft 54B is connected to the linkage 59 through a second transfer linkage 59B.

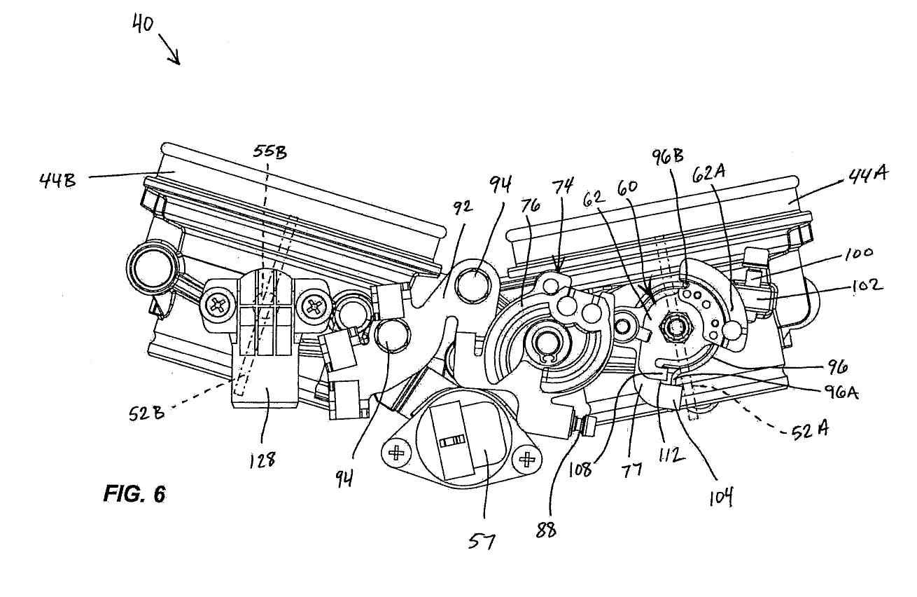

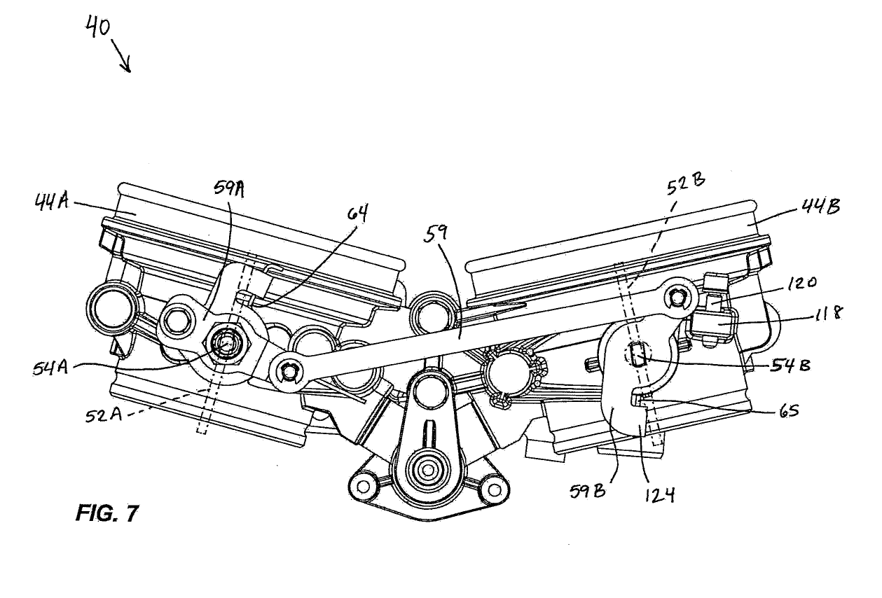

The first throttle plate 52A and the first shaft 54A are rotatable about an axis A, which is defined by the first shaft 54A. The first throttle plate 52A and the first shaft 54A are rotatable about the axis A between a first (“closed”) position illustrated in at least FIGS. 2-5 and a second (“open”) position illustrated in at least FIGS. 6 and 7. The second throttle plate 52B and the second shaft 54B are rotatable about an axis B, which is defined by the second shaft 54B. The second throttle plate 52B and the second shaft 54B are rotatable about the axis B between a first (or “closed” position) illustrated in at least FIGS. 2-5 and a second (or “open”) position illustrated in at least FIGS. 6 and 7.

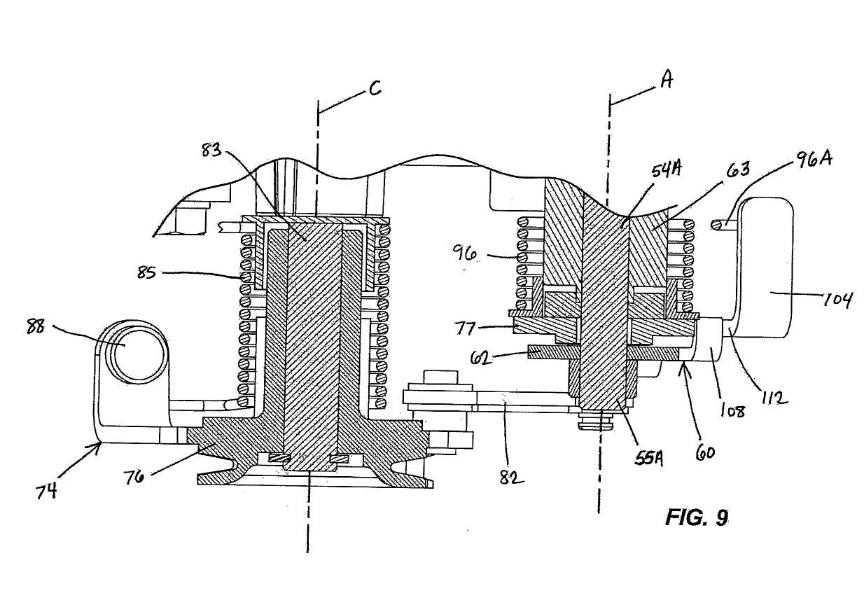

A first actuator 60 is coupled to the first end 55A of the first shaft 54A. The first actuator 60 includes a first cable wheel 62 mounted adjacent a projection 63 (FIG. 9) of the first throttle body 44A and coaxial therewith. The projection 63 extends from the first throttle body 44A and can be formed (e.g., cast, forged, etc.) as part of the first throttle body 44A or mounted to the first throttle body 44A. The first cable wheel 62 is directly coupled to the first shaft 54A and rotatable about the axis A between a first position and a second position corresponding to the first and second positions of the first shaft 54A and the first throttle plate 52A. Rotation of the first cable wheel 62 directly modulates the orientation of the first throttle plate 52A within the air passage 46A with a 1:1 rotation ratio (i.e., the first throttle plate 52A rotates one degree for every one degree of rotation of the first cable wheel 62). The orientation of the second plate 52B within the second air passage 46B is also modulated in a 1:1 ratio with the rotation of the first cable wheel 62 and the first throttle plate 52A via the linkage 59. A first biasing member (e.g., torsion spring 64) biases the first throttle plate 52A (and with it, the first cable wheel 62) to the first (“closed”) position (FIGS. 2-5). The torsion spring 64 is positioned adjacent the second end 56A of the first shaft 54A. Through the linkage 59 and the transfer linkages 59A, 59B, the second throttle plate 52A is also biased to the first (“closed”) position. A second biasing member (e.g., torsion spring 65) positioned adjacent the second end 56B of the second shaft 54B provides an additional biasing force that biases the second throttle plate 52B to the first (“closed”) position. The torsion spring 65 directly engages the second transfer linkage 59B and further biases the second throttle plate 52B to the first (“closed”) position

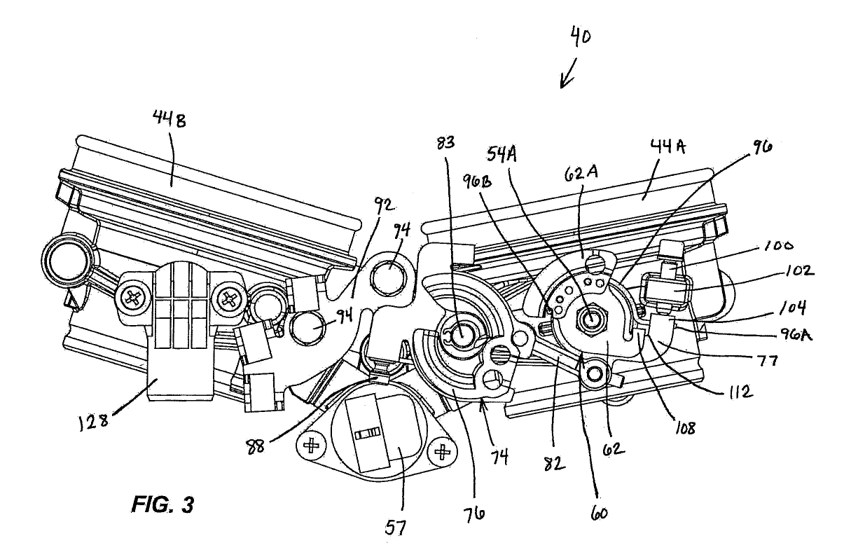

A cable 66 is connected to the first cable wheel 62 at an attachment portion 62A of the first cable wheel 62. The cable 66 extends from the attachment portion 62A to an electronic actuation device 68, which is remote from the throttle assembly 40 as schematically illustrated in FIG. 2. The electronic actuation device 68 is operable to selectively apply a force through the cable 66 to the first cable wheel 62 to rotate the first cable wheel 62 about the axis A. Thus, the first cable wheel 62 is an electrically operable actuator configured to selectively control the first and second throttle plates 52A, 52B. The electronic actuation device 68 is operable to selectively rotate the first cable wheel 62 in one direction (counter-clockwise in FIGS. 3, 6, and 8), but not necessarily in the opposite direction (clockwise in FIGS. 3, 6, and 8) as discussed in further detail below. The illustrated electronic actuation device 68 is a solenoid. However, in other constructions, the electronic actuation device 68 can include electric motors and/or other prime movers. As explained in greater detail below, the electronic actuation device 68 is coupled to an engine control module 72 (FIG. 2), which selectively triggers the electronic actuation device 68 (e.g., by an electrical signal) to pull the cable 66.

A second actuation device 74 includes a second cable wheel 76, a second actuator 77 (e.g., wheel actuator), a throttle control (e.g., hand-operable throttle grip 78), a first cable 80, and a second cable 81. The second actuation device 74 is a manually operable actuation device, operable to selectively modulate the orientations of the first and second throttle plates 52A, 52B in either direction between open and closed positions. The throttle grip 78 is rotatable about an axis D and coupled with the first and second cables 80, 81, which are coupled to the second cable wheel 76. A linkage 82 couples the second cable wheel 76 and the second actuator 77 such that rotation of the second cable wheel 76 rotates the second actuator 77 accordingly. The second cable wheel 76 is mounted on a projection 83 of the first throttle body 44A and is rotatable about an axis C defined by the projection 83 (FIG. 9). The projection 83 can be formed (e.g., cast, forged, etc.) as part of the first throttle body 44A or mounted to the first throttle body 44A. The second actuator 77 is mounted adjacent the first cable wheel 62 coaxial with the projection 63 of the first throttle body 44A and the first cable wheel 62 and is rotatable about the axis A as described further below.

The second cable wheel 76 is biased to a first position (FIGS. 2-5) by a biasing member (e.g., torsion spring 85). The torsion spring 85 is mounted on the projection 83 and engaged with the second cable wheel 76. An adjustable stop 88 is coupled to the second cable wheel 76 and engageable with a limit plate 90 secured to the throttle assembly 40. The limit plate 90 is part of a cable guide plate 92, which guides the cables 80 and 81, and which is coupled to the throttle assembly 40 with a pair of fasteners (e.g., threaded bolts 94). The torsion spring 85 biases the second cable wheel 76 toward the first position in which the stop 88 contacts the limit plate 90 (i.e., the biasing force is clockwise in FIGS. 3, 6, and 8). In order to rotate the second cable wheel 76 away from the first position (counter-clockwise in FIGS. 3, 6, and 8), the bias of the torsion spring 85 must be overcome by the torque applied to the second cable wheel 76 by the throttle grip 78 through the first cable 80 of the second actuation device 74.

At rest (no actuation by the throttle grip 78 or the electronic actuation device 68), the second actuator 77 is biased to the first position (FIGS. 2-5) by a biasing member (e.g., torsion spring 96). The biasing member 96 provides a biasing force in the counter-clockwise direction in FIGS. 3, 6, and 8. An adjustable stop 100 is mounted on a projection 102 on the first throttle body 44A. A limit portion 104 (e.g., flange) of the second actuator 77 engages the stop 100 under the bias of the torsion spring 96 to hold the second actuator 77 in the position shown in FIGS. 2 and 3. The torsion spring 96 includes a first end 96A engaged with a lower surface of the limit portion 104 of the second actuator 77 and a second end 96B engaged with the first cable wheel 62. Thus, the torsion spring 96 is positioned between the first cable wheel 62 and the second actuator 77. The torsion spring 64 biases the throttle plates 52A, 52B and the first cable wheel 62 to the first (“closed”) positions, and the torsion spring 96 biases the second actuator 77 toward the stop 100. The first cable wheel 62 includes a limit portion 108 (e.g., flange) that is received by a recess 112 of the second actuator 77 under the bias of the torsion spring 96 in the at rest state (FIGS. 2-5).

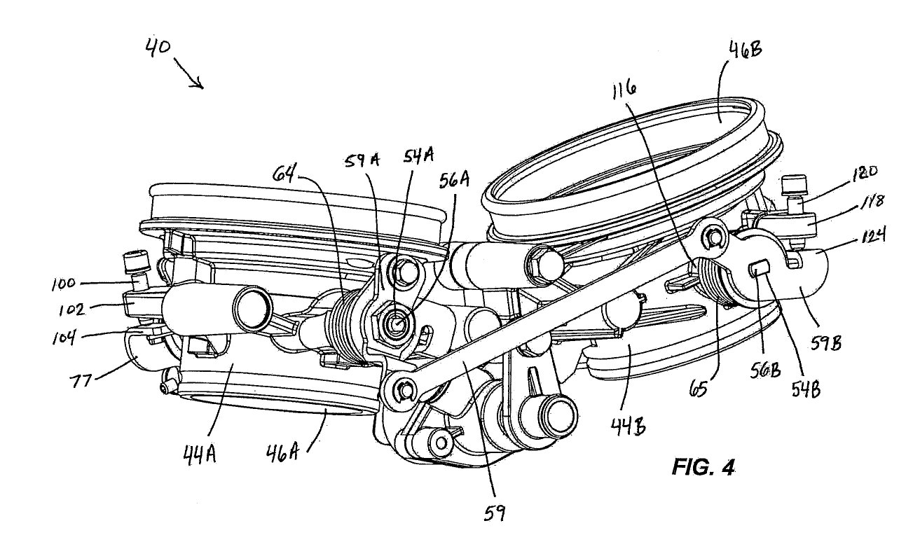

As shown in FIG. 4, the torsion spring 65 is mounted on a projection 116 of the second throttle body 44B and is configured to bias the second shaft 54B and the second throttle plate 52B to the first (“closed”) positions (FIGS. 2-5). The torsion spring 65 is engaged with the second transfer linkage 59B and with a projection 118 (separate from the projection 116) on the second throttle body 44B to bias the second transfer linkage 59B, and thus the second shaft 54B and the second throttle plate 52B, to the respective first (“closed”) positions. An adjustable stop 120 is coupled to the projection 118. A limit portion 124 of the second transfer link 59B is engaged with the stop 120 under the bias of the torsion spring 65 when the throttle assembly 40 is in the at-rest state (FIGS. 2-5).

The first cable wheel 62 is driven by rotation of the second actuator 77 under normal operating conditions. For example, when the second cable wheel 76 is actuated (counter-clockwise in FIGS. 3, 6, and 8) by the first cable 80, the second actuator 77 is driven by the linkage 82 to rotate (clockwise in FIGS. 3, 6, and 8) so that the limit portion 104 is moved off of the stop 100. The second actuator 77 drives the rotation of the first cable wheel 62 through the inter-connected torsion spring 96. Under normal operating conditions, the electronic actuation device 68 is not activated and the cable 64 does not prevent or limit the first cable wheel 62 from rotating with the second actuator 77.

Returning to FIG. 2, the throttle grip 78 is rotatable about the axis D to manipulate the second cable wheel 76 through the first and second cables 80 and 81. Rotation of the throttle grip 78 in a first direction about the axis D creates tension in the first cable 80, which rotates the second cable wheel 76 in a first direction (counter-clockwise in FIGS. 3, 6, and 8), overcoming the bias of the torsion spring 85, and rotating the first and second throttle plates 52A and 52B toward the open positions (FIGS. 6 and 7). Rotation of the throttle grip 78 back toward the position of FIG. 2 (the idle, at-rest position) allows the second cable wheel 76 to rotate back to its first position (as shown in FIG. 2) by the bias of the torsion spring 85 and tension provided by the second cable 81. One or more additional biasing members (such as a torsion spring inside the throttle grip 78) may be incorporated to return the throttle grip 78 and the second cable wheel 76 to the positions of FIG. 2.

As illustrated in FIGS. 2, 3, 5, 6, and 8, a position sensor 128 is coupled to the throttle assembly 40 adjacent the first end 55B of the second shaft 54B. The position sensor 128 is operable to sense the amount of rotation and/or the absolute position of the second shaft 54B (which is equivalent to the amount of rotation of the first shaft 54A) to determine the orientation of the throttle plates 52A, 52B within the respective air passages 46A, 46B. This information is communicated to the engine control module 72, which uses the information to control fuel delivery, among other things. For example, based upon the sensed rotational position of the second shaft 54B, the engine control module 72 can determine the airflow into the engine 18. As such, the engine control module 72 can direct one or more fuel injectors (not illustrated) to deliver an amount of fuel corresponding to the airflow to maintain desired combustion parameters (i.e., to prevent backfires and misfires, etc. and to promote a desired air/fuel ratio).

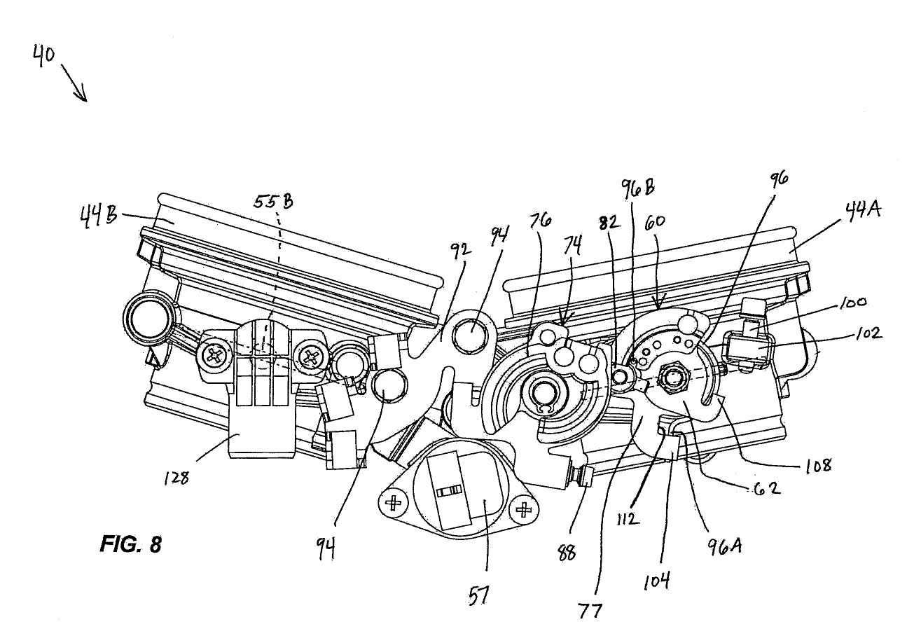

The engine control module 72 also controls the electronic actuation device 68. The engine control module 72 senses a variety of operational parameters, such as engine speed, motorcycle speed, throttle position. The engine control module 72 actuates the electronic actuation device 68 when one or more of the parameters are within a predetermined range. Upon actuation of the electronic actuation device 68, the first cable wheel 62 rotates relative to the second actuator 77, as shown in FIG. 8, to cause the throttle plates 52A, 52B to restrict the air passages 46A, 46B. This controls the power output of the engine 18. By using relative rotation of the first cable wheel 62 with respect to the second actuator 77 to restrict the air passages 46A, 46B and control the power output, combustion conditions remain relatively optimal at all times. Specifically, by controlling the position of the throttle plates 52A, 52B, both the airflow and the fuel delivery are controlled proportionately. In addition, by controlling the power of the output of the engine 18, traction of the rear wheel can be improved in slippery conditions.

The operation of the illustrated intake power control will now be described beginning with the motorcycle 10 idling. When the motorcycle is idling, the throttle plates 52A, 52B, the first cable wheel 62, the second actuator 77, and the second cable wheel 76 are in their idle positions, as shown in FIGS. 2-5, 9, and 10. Upon actuation of the throttle grip 78, the second cable wheel 76 rotates in a counter-clockwise direction as viewed in FIGS. 3, 6, and 8. Rotation of the second cable wheel 76 causes the second actuator 77 to rotate a proportional amount in the opposite direction (clockwise as viewed in FIGS. 3, 6, and 8) via the linkage 82. Clockwise rotation of the second actuator 77 causes rotation of the first cable wheel 62 of a substantially equal amount via the torsion spring 96, which is stiff enough to not deflect significantly when the second actuator 77 is rotated away from the stop 100. Because the first cable wheel 62 is directly coupled to the shaft 54A, rotation of the first cable wheel 62 then causes the shaft 54A to rotate and change the orientation of the throttle plate 52A relative to the air passage 46A. This allows more air to pass through the passage 46A and the power output of the engine 18 to increase. As the first shaft 54A and the first throttle plate 52A rotate from closed to open positions about axis A, the second shaft 54B and the second throttle plate 52B are driven to rotate via the linkage 59 a substantially equal amount about the axis B. In this manner, the throttle plates 52A, 52B can be rotated from the respective first (“closed”) positions to respective second positions, such as the wide open throttle positions as illustrated in FIGS. 6 and 7.

From the wide open throttle condition illustrated in FIGS. 6 and 7 (or another open throttle position), the second cable wheel 76 can be rotated in the opposite direction (clockwise in FIGS. 3, 6, and 8), which will cause the second actuator 77 and the first cable wheel 62 to rotate a proportional amount to change the orientation of the throttle plates 52A, 52B toward the first (“closed”) positions. During the clockwise rotation, the power of the engine 18 is reduced as the throttle plate 52A restricts the air passage 46A and the throttle plate 52B restricts the air passage 46B (both throttle plates 52A and 52B moving toward the positions illustrated in FIGS. 2-5 and 9-10). Specifically, this provides less air for combustion.

As previously indicated, the engine control module 72 continuously receives information regarding a variety of operation parameters of the motorcycle 10, such as vehicle speed, engine speed, throttle position, and the like. These parameters are evaluated to determine whether they fall within a predetermined range defining a triggering event. One or more triggering events can be programmed into the engine control module 72. For example, in one embodiment the triggering event occurs when the motorcycle is traveling at about thirty miles-per-hour and the engine is operating at a corresponding speed indicating the motorcycle is traveling at a constant speed (i.e., with little acceleration, if any). In addition to the two parameters, the sensed position of the throttle plates 52A, 52B by the throttle position sensor 128 must indicate an intent by the rider to substantially accelerate the motorcycle 10 (e.g., movement of the throttle plates 52A, 52B from a position corresponding to traveling at nearly a constant speed of about thirty miles-per-hour to a nearly fully-open position). Upon sensing these three conditions, the engine control module 72 quickly overrides the user input from the throttle grip 78 to limit the rate of acceleration of the motorcycle 10. Specifically, the engine control module 72 moves the throttle plates 52A, 52B to respective positions that reduce the power output of the engine 18 by restricting air flow to the engine 18.

During an override, the engine control module 72 actuates the electronic actuation device 68, which causes the first cable wheel 62 to rotate in a counter-clockwise direction relative to the second actuator 77 as illustrated in FIG. 8. When the engine control module 72 overrides the user input, the first cable wheel 62 rotates independently of the second actuator 77, overcoming the bias of the torsion spring 96. The counter-clockwise rotation of the first cable wheel 62 causes the throttle plate 52A to rotate from the wide open throttle position (or another open position) to a position that further restricts the air passage 46A. Because of the connection through the linkage 59, the second throttle plate 52B is also moved to a position that further restricts the air passage 46B. Thus, the engine control module 72 allows the operator to reach a desired traveling speed while limiting the maximum power delivered from the engine 18.

The engine control module 72 and the electronic actuation device 68 can be programmed or configured to override the input of the throttle grip 78 by a predetermined percentage, which may or may not depend upon the specific circumstances that triggered the override. Alternately, the engine control module 72 can control the electronic actuation device 68 to move the first cable wheel 62 to a predetermined orientation regardless of the conditions that triggered the override. The relative rotation of the first cable wheel 62 with respect to the second actuator 77 during override is limited by the degree of actuation of the electronic actuation device 68 and/or a physical limiting device on or adjacent the first cable wheel 62.

Once one or more of the sensed parameters fall outside of the predetermined range, the engine control module 72 will no longer override the user input. Rather, engine control module 72 will return control of the throttle plates 52A, 52B to the user. Although control can be transferred to the user very quickly by actuating the electronic actuation device 68 to the non-override position, the engine control module 72 of the illustrated embodiment transfers control back to the user gradually. A very quick transfer could cause a sudden increase of power. Thus, in the illustrated embodiment, the solenoid is pulse width modulated from the override position to the non-override position. Thus, a gradual increase of power is achieved when the override event ceases.

The engine control module 72 can temporarily override the user's input for a variety of reasons. For example, as just described, the engine control module 72 can control the acceleration of the motorcycle 10 in predetermined situations. This can help the rider maintain better control over the motorcycle 10. In some situations, depending upon the horsepower and torque of the engine 18, sudden acceleration can cause the front wheel of the motorcycle to leave the ground. The engine control module 72 can be programmed to improve the traction of the rear wheel with the ground during acceleration.

Additionally, the engine control module 72 can reduce the noise emissions of the motorcycle. By controlling the power of the motorcycle 10 with the throttle plates 52A, 52B, the noise emitted from the motorcycle 10 is also controlled. Conventional power control techniques may cut off fuel to the engine 18 or eliminate/reduce the spark. These techniques, unlike the present invention, caused greater noise emissions in some circumstances due to backfires and misfired caused by lean running conditions. Specifically, the lean running conditions occur when the air-to-fuel ratio is not optimal. In the present invention, combustion occurs with an optimal air-to-fuel ratio even when the engine control module 72 overrides the user's input to reduce the power. As indicated above, the amount of fuel delivered is dependent upon the sensed position of the throttle plates 52A and 52B. As such, when the engine control module 72 reduces the power of the engine by moving the throttle plates 52A, 52B, the fuel delivery is also altered corresponding to the sensed position of the throttle plates 52A, 52B. Consequently, the engine 18 does not run lean and does not backfire or misfire.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features and advantages of the invention are set forth in the following claims.

What is claimed is:

1. An intake power control for an engine comprising:
a first throttle body defining a first air intake passage of the engine;
a first throttle plate positioned within the first throttle body and movable between an idle position allowing a first amount of air to flow through the first air intake passage and a second position allowing more than the first amount of air to flow through the first air intake passage;
an electrically operable actuator coupled to the first throttle plate, movement of the electrically operable actuator directly causing movement of the first throttle plate;
a manually operable actuator coupled to the electrically operable actuator, movement of the manually operable actuator selectively causing movement of the first throttle plate;
a second throttle body defining a second air intake passage of the engine;
a second throttle plate positioned within the second throttle body and movable between an idle position allowing a first amount of air to flow through the second air intake passage and a second position allowing more than the first amount of air to flow through the second air intake passage;
a linkage coupling the first throttle plate and the second throttle plate, the linkage movable in response to movement of the first throttle plate to synchronize the movement of the second throttle plate with the movement of the first throttle plate.

2. The intake power control of claim 1, wherein the first throttle plate is rotatable about a first axis and the second throttle plate is rotatable about a second axis parallel to the first axis.

3. The intake power control of claim 2, wherein the second throttle plate is rotated about the second axis in a direction opposite to a direction of rotation of the first throttle plate about the first axis.

4. The intake power control of claim 1, wherein the electrically operable actuator and the manually operable actuator are positioned adjacent a first side of the first throttle body and the linkage is positioned adjacent an opposite side of the first throttle body.

5. The intake power control of claim 1, further comprising a first transfer link directly coupled to the first throttle plate and a second transfer link directly coupled to the second throttle plate, both the first transfer link and the second transfer link being directly coupled to the linkage.

6. The intake power control of claim 1, wherein the manually operable actuator includes a cable wheel, a throttle control, and at least one cable coupled between the cable wheel and the throttle control such that rotation of the throttle control rotates the cable wheel to selectively cause movement of the first throttle plate.

7. The intake power control of claim 6, wherein the manually operable actuator includes an actuator wheel coupled to the cable wheel through a linkage.

8. The intake power control of claim 7, wherein the actuator wheel is coaxial with the electrically operable actuator about the first axis.

9. A motorcycle comprising:
an engine;
a first throttle body defining a first air intake passage into the engine;
a second throttle body defining a second air intake passage into the engine;
a first throttle plate movable within the first throttle body to vary the flow of air through the first air intake passage;
a second throttle plate movable within the second throttle body to vary the flow of air through the second air intake passage;
a manually operable actuator movable to move the first throttle plate;
a linkage coupling the first throttle plate and the second throttle plate to synchronize the movement of the first and second throttle plates; and
an electronic override device coupled to the first throttle plate to selectively adjust the movement of the first and second throttle plates initiated by the manually operable actuator.

10. The motorcycle of claim 9, wherein the manually operable actuator includes a throttle control.

11. The motorcycle of claim 10, wherein the manually operable actuator includes a cable wheel and at least one cable coupled between the throttle control and the at least one cable.

12. The motorcycle of claim 9, wherein the electronic override device includes an electrically operable actuator directly coupled to the first throttle plate.

13. The motorcycle of claim 12, wherein the electronic override device includes a solenoid coupled to the electrically operable actuator.

14. The motorcycle of claim 9, wherein the first throttle plate is coupled to a first shaft and the second throttle plate is coupled to a second shaft, the first shaft and the second shaft being parallel.

15. The motorcycle of claim 14, wherein the first shaft defines a first axis and the second shaft defines a second axis, the first throttle plate being rotatable about the first axis in a first direction, and the second throttle plate being rotatable by the linkage about the second axis in a second direction opposite the first direction.

16. A method of controlling a motorcycle engine having two throttle bodies defining first and second air intake passages, first and second throttle plates being positioned within the first and second air intake passages, respectively, the method comprising:
operating the engine;
manually actuating the first throttle plate with a throttle control to increase the amount of air entering the engine through the first air intake passage;
automatically actuating the second throttle plate in association with the first throttle plate to increase the amount of air entering the engine through the second air intake passage;
sensing a triggering condition;
electrically actuating the first throttle plate to decrease the amount of air entering the engine through the first air intake passage without moving the throttle control; and
automatically actuating the second throttle plate in association with the first throttle plate to decrease the amount of air entering the engine through the second air intake passage.

17. The method of claim 16, wherein automatically actuating the second throttle plate with the first throttle plate includes transferring rotation of the first throttle plate through a linkage to the second throttle plate.

18. The method of claim 17, further comprising rotating the second throttle plate through an angle of the same magnitude as the first throttle plate in an opposite direction as compared to the rotation of the first throttle plate.

19. The method of claim 16, wherein manually actuating the first throttle plate includes rotating a manually operable actuator with a cable from the throttle control, the manually operable actuator rotating a secondary actuator through a torsion spring, the secondary actuator being directly coupled to the first throttle plate.

20. The method of claim 19, wherein the secondary actuator is an electrically operable actuator and electrically actuating the first throttle plate includes actuating the electrically operable actuator with an electrically-powered device to torsionally deflect the torsion spring and rotate the first throttle plate relative to the manually operable actuator.
